(19) United States
(12) Patent Application Publication
(10) Pub. No.: US 2019/0194418 A1
(43) Pub. Date: Jun. 27, 2019

(54) HYDROGEL COMPOSITION, CONTACT LENS, AND METHOD FOR MANUFACTURING THE SAME

(71) Applicant: HON HAI PRECISION INDUSTRY CO., LTD., New Taipei (TW)

(72) Inventors: HSIU-WEN CHIEN, New Taipei (TW); WEN-KAI LI, New Taipei (TW)

(21) Appl. No.: 15/920,603

(22) Filed: Mar. 14, 2018

(30) Foreign Application Priority Data
Dec. 26, 2017 (CN) 201711435145.4

(51) Int. Cl. C08K 5/07; G02B 1/04; B29D 11/00

(52) U.S. Cl. CPC C08K 5/07; B29K 2105/0061; B29D 11/00134; G02B 1/043

(57) ABSTRACT

A contact lens is disclosed. The contact lens includes a gel substrate. The gel substrate includes astaxanthin having a mass percentage of 0.004% to 5%. The hydrogel composition and a method for manufacturing the contact lens are also disclosed.

### FIELD

The subject matter generally relates to a hydrogel composition, a contact lens and a method for manufacturing a contact lens.

### BACKGROUND

Contact lenses are widely used. Wearing a contact lens for a long time subject the eyes to inflammation, fatigue, and other symptoms. Astaxanthin is a natural dye that has good anti-oxidant ability, anti-glare properties, and can also treat inflammation. Therefore, people often use ophthalmic medicine that contains astaxanthin to alleviate the above eye problems. Improvement in the art is desired to apply the beneficiary effects of astaxanthin to contact lenses.

### BRIEF DESCRIPTION OF THE DRAWING

Implementations of the present disclosure will now be described, by way of example only, with reference to the attached FIGURE.

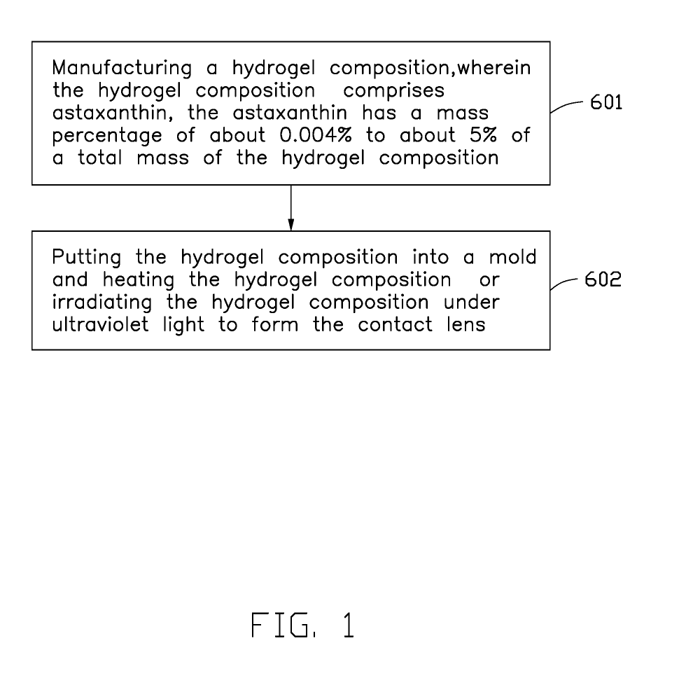

The FIGURE (FIG. 1) is a flowchart of a method for manufacturing a contact lens.

### DETAILED DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

The present disclosure provides an exemplary embodiment of a hydrogel composition. The hydrogel composition is comprised of astaxanthin, hydrophilic monomer, cross-linking agent, and initiator. The astaxanthin is combined and dispersed in the hydrophilic monomer, the cross-linking agent, and the initiator.

In at least one exemplary embodiment, the astaxanthin has a mass percentage of 0.004% to 5% of a total mass of the hydrogel composition, the hydrophilic monomer has a mass percentage of 56% to 99.82% of the total mass of the hydrogel composition, the cross-linking agent has a mass percentage of 0.03% to 21.82% of the total mass of the hydrogel composition, and the initiator has a mass percentage of 0.042% to 18.62% of the total mass of the hydrogel composition.

The astaxanthin (3,3′-Dihydroxy-beta,beta-carotene-4,4′-dione) is a terpene unsaturated compound.

The astaxanthin has a chemical formula of C₄₀H₅₂O₄.

The astaxanthin has a chemical structural diagram of

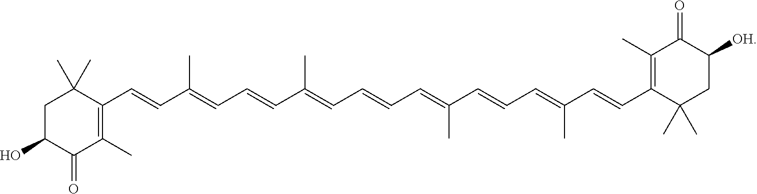 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

The astaxanthin is widely found in nature, such as most crustaceans and salmonids, plant leaves, flowers, fruit, and flamingo feathers. The astaxanthin has a variety of physiological effects, such as anti-oxidant, anti-tumor, cancer prevention, immunity enhancer, and improves vision.

The hydrophilic monomers may include methacryloxyalkylsiloxanes, 3-methacryloxypropylpentamethyldisiloxane, bis(methacryloxypropyl)tetramethyldisiloxane, monomethacrylatedpolydimethyl siloxane, mercapto-terminatedpolydimethyl siloxane, N-[tri s(trimethyl siloxy)silylpropyl]acrylamide, N-[tri s(trimethyl siloxy)silylpropyl]methacrylamide, tris(pentamethyldisiloxyanyl)-3-methacrylatopropyl silane (T2), 3-methacryloxypropyletris(trimethylsiloxy)silane, 2-hydroxyethylmethacrylate (HEMA), hydroxyethyl acrylate, hydroxypropyl acrylate, hydroxypropyl methacrylate (HPMA), tri methyl ammonium 2-hydroxy propylmethacrylate hydrochloride, dimethylaminoethyl methacrylate (DMAEMA), dimethylaminoethylmethacrylamide, acrylamide, methacrylamide, allyl alcohol, vinylpyridine, glycerol methacrylate, N-(1,1dimethyl-3-oxobutyl)acrylamide, N-vinyl-2-pyrrolidone (NVP), acrylic acid, methacrylic acid, and N,N-dimethyacrylamide, or any combination thereof

The cross-linking agent may include ethylene glycol dimethacrylate (EGDMA), trimethylolpropane trimethacrylate (TMPTMA), tri (ethylene glycol) dimethacrylate (TEGDMA), tri(ethylene glycol) divinyl ether (TEGDVE), and trimethylene glycol dimethacrylate, or any combination thereof

The initiator may be a photoinitiator or a thermal initiator.

The photoinitiator may include benzoin methyl ether, diethoxy acetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator, or any combination thereof.

The benzoylphosphine oxide initiator may include 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, or any combination thereof.

In at least one exemplary embodiment, the Darocur type initiator can be Darocur-1173and Darocur-2959.

In at least one exemplary embodiment, the Irgacur type initiator can be Irgacure-1173.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxide, and any combination thereof. The peroxide can be benzoyl peroxide.

FIG. 1 illustrates a flowchart of a method for manufacturing a contact lens. The method is provided by way of example, as there are a variety of ways to carry out the method. The method described below can be carried out using the configurations illustrated in FIG. 1. Each block shown in FIG. 1 represents one or more processes, methods, or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 601.

At block 601, a hydrogel composition is manufactured. The hydrogel composition includes astaxanthin. The astaxanthin has a mass percentage of about 0.004% to about 5% of a total mass of the hydrogel composition. The astaxanthin (3,3′-Dihydroxy-beta,beta-carotene-4,4′-dione) is a terpene unsaturated compound.

Chemical formula for the astaxanthin is C₄₀H₅₂O₄.

The astaxanthin has a chemical structural diagram of

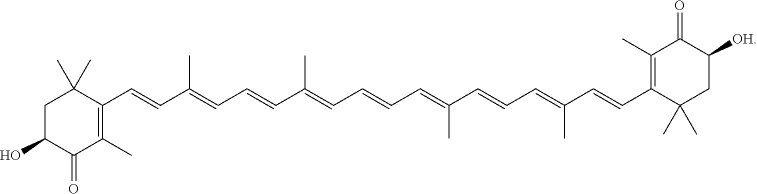 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

The hydrogel composition further includes hydrophilic monomer, cross-linking agent, and initiator. The astaxanthin is dispersed in the hydrophilic monomer, the cross-linking agent, and the initiator.

In at least one exemplary embodiment, the hydrophilic monomer has a mass percentage of 56% to 99.82% of the total mass of the hydrogel composition, the cross-linking agent has a mass percentage of 0.03% to 21.82% of the total mass of the hydrogel composition, and the initiator has a mass percentage of 0.042% to 18.62% of the total mass of the hydrogel composition.

The hydrophilic monomers may include methacryloxyalkylsiloxanes, 3-methacryloxypropylpentamethyldisiloxane, bis(methacryloxypropyl)tetramethyl-disiloxane, monomethacrylatedpolydimethyl siloxane, mercapto-terminatedpolydimethyl siloxane, N-[tris(trimethylsiloxy)silylpropyl]acrylamide, N-[tris(trimethylsiloxy)silylpropyl]methacrylamide, tris(pentamethyldisiloxyanyl)-3-methacrylatopropyl silane (T2), 3-methacryloxypropyletris(trimethylsiloxy)silane, 2-hydroxyethylmethacrylate (HEMA), hydroxyethyl acrylate, hydroxypropyl acrylate, hydroxypropyl methacrylate (HPMA), trimethylammonium 2-hydroxy propylmethacrylate hydrochloride, dimethylaminoethyl methacrylate (DMAEMA), dimethylaminoethylmethacrylamide, acrylamide, methacrylamide, allyl alcohol, vinylpyridine, glycerol methacrylate, N-(1,1dimethyl-3-oxobutyl)acrylamide, N-vinyl-2-pyrrolidone (NVP), acrylic acid, methacrylic acid, and N,N-dimethyacrylamide, or any combination thereof

The cross-linking agent may include ethylene glycol dimethacrylate (EGDMA), trimethylolpropane trimethacrylate (TMPTMA), tri (ethylene glycol) dimethacrylate (TEGDMA), tri(ethylene glycol) divinyl ether (TEGDVE), and trimethylene glycol dimethacrylate, or any combination thereof

The initiator may be a photoinitiator or a thermal initiator.

The photoinitiator may include benzoin methyl ether, diethoxy acetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator, or any combination thereof.

The benzoylphosphine oxide initiator may include 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, or any combination thereof.

In at least one exemplary embodiment, the Darocur type initiator can be Darocur-1173 and Darocur-2959.

In at least one exemplary embodiment, the Irgacur type initiator can be Irgacure-1173.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxide, and any combination thereof. The peroxide can be benzoyl peroxide.

At block 602, the hydrogel composition is put into a mold and is heated or irradiated under ultraviolet light to form the contact lens.

After heating or irradiating under ultraviolet light, the hydrophilic monomer, the cross-linking agent, and the initiator undergo a polymerization reaction to form a cross-linking network. The astaxanthin is combined and dispersed in the cross-linking network.

In at least one exemplary embodiment, the hydrogel composition is heated between 0.5 hours to 8 hours at a temperature between 60 degrees Celsius to 90 degrees Celsius. In another embodiment, the hydrogel composition is irradiated under ultraviolet light between 5 minutes to 30 minutes.

### EXAMPLE 1

Astaxanthin, 2-hydroxyethylmethacrylate, ethylene glycol dimethacrylat, and azobisisobutyronite are provided and mixed to form a hydrogel composition. The astaxanthin has a mass percentage of 0.97% of the total mass of the hydrogel composition, the 2-hydroxyethylmethacrylate has a mass percentage of 98.25% of the total mass of the hydrogel composition, the ethylene glycol dimethacrylat has a mass percentage of 0.52% of the total mass of the hydrogel composition, and the azobisisobutyronite has a mass percentage of 0.26% of the total mass of the hydrogel composition.

The hydrogel composition is put into a mold to heat 5 hours at a temperature of 65 degrees Celsius to form a contact lens.

### EXAMPLE 2

Astaxanthin, 2-hydroxyethylmethacrylate, ethylene glycol dimethacrylat, and azobisisobutyronite are provided and mixed to form a hydrogel composition. The astaxanthin has a mass percentage of 0.067% of the total mass of the hydrogel composition. The 2-hydroxyethylmethacrylate has a mass percentage of 97.373% of the total mass of the hydrogel composition. The ethylene glycol dimethacrylat has a mass percentage of 1.02% of the total mass of the hydrogel composition. The azobisisobutyronite has a mass percentage of 1.54% of the total mass of the hydrogel composition.

The hydrogel composition is put into a mold and heated for 8 hours at a temperature of 60 degrees Celsius to form a contact lens.

The present disclosure also provides an exemplary embodiment of a contact lens.

The contact lens includes a gel substrate. The gel substrate includes astaxanthin, hydrophilic monomer, cross-linking agent, and initiator. The astaxanthin is combined and dispersed in a cross-linking network formed from the hydrophilic monomer, the cross-linking agent, and the initiator.

In at least one exemplary embodiment, the astaxanthin has a mass percentage of about 0.004% to about 5% of the total mass of the gel substrate, and the hydrophilic monomer has a mass percentage of about 56% to about 99.82% of the total mass of the gel substrate. The cross-linking agent has a mass percentage of about 0.03% to about 21.82% of the total mass of the gel substrate, and the initiator has a mass percentage of about 0.042% to about 18.62% of the total mass of the gel substrate.

The astaxanthin has a chemical structural diagram of

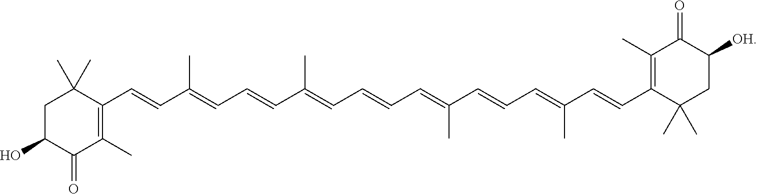 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

The hydrophilic monomers may include methacryloxyalkylsiloxanes, 3-methacryloxypropylpentamethyldisiloxane, bis(methacryloxypropyl)tetramethyl-disiloxane, monomethacrylatedpolydimethylsiloxane, mercapto-terminatedpolydimethylsiloxane, N4tris(trimethylsiloxy)silylpropyl]acrylamide, N4tris(trimethylsiloxy)silylpropyl]methacrylamide, tris(pentamethyldisiloxyanyl)-3-methacrylatopropyl silane (T2), 3-methacryloxypropyletris(trimethylsiloxy)silane, 2-hydroxyethylmethacrylate (HEMA), hydroxyethyl acrylate, hydroxypropyl acrylate, hydroxypropyl methacrylate (HPMA), tri methyl ammonium 2-hydroxy propylmethacrylate hydrochloride, dimethylaminoethyl methacrylate (DMAEMA), dimethylaminoethylmethacrylamide, acrylamide, methacrylamide, allyl alcohol, vinylpyridine, glycerol methacrylate, N-(1,1dimethyl-3-oxobutyl)acrylamide, N-vinyl-2-pyrrolidone (NVP), acrylic acid, methacrylic acid, and N,N-dimethyacrylamide, or any combination thereof

The cross-linking agent may include ethylene glycol dimethacrylate (EGDMA), trimethylolpropane trimethacrylate (TMPTMA), tri (ethylene glycol) dimethacrylate (TEGDMA), tri(ethylene glycol) divinyl ether (TEGDVE), and trimethylene glycol dimethacrylate, or any combination thereof

The initiator may be a photoinitiator or a thermal initiator.

The photoinitiator may include benzoin methyl ether, diethoxy acetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator, or any combination thereof

The benzoylphosphine oxide initiator may include 2, 4, 6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, or any combination thereof.

In at least one exemplary embodiment, the Darocur type initiator can be Darocur-1173 and Darocur-2959.

In at least one exemplary embodiment, the Irgacur type initiator can be Irgacure-1173.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxide, and any combination thereof. The peroxide can be benzoyl peroxide.

The photoinitiator may include benzoin methyl ether, diethoxy acetophenone, a benzoylphosphine oxide initiator, ethyl 2-dimethylaminobenzoate, 2-isopropylthioxanthone, 1-hydroxycyclohexyl phenyl ketone, Darocur type initiator and Irgacur type initiator, or any combination thereof

The benzoylphosphine oxide initiator may include 2,4,6-trimethylbenzoyldiphenylophosphine oxide, bis-(2,6-dichlorobenzoyl)-4-N-propylphenylphosphine oxide, and bis-(2,6-dichlorobenzoyl)-4-N-butylphenylphosphine oxide, or any combination thereof.

In at least one exemplary embodiment, the Darocur type initiator can be Darocur-1173 and Darocur-2959.

In at least one exemplary embodiment, the Irgacur type initiator can be Irgacure-1173.

The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), and peroxide, and any combination thereof. The peroxide can be benzoyl peroxide.

With the above configuration, the hydrogel composition and the contact lens all include astaxanthin. The astaxanthin is combined and dispersed in the hydrogel composition and the contact lens, so chemical structure of the astaxanthin is unbroken. The astaxanthin is released into eyes when the contact lens are worn, thereby the contact lens can relieve or cure inflammation, fatigue, and other symptoms in real time.

The embodiments shown and described above are only examples. Many details are often found in the art such as the other features of the contact lens. Therefore, many such details are neither shown nor described. Even though numerous characteristics and advantages of the present disclosure have been positioned forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims. It will therefore be appreciated that the embodiments described above can be modified within the scope of the claims.

What is claimed is:

1. A hydrogel composition comprising astaxanthin, wherein the astaxanthin has a mass percentage of 0.004% to 5%.

2. The hydrogel composition of claim 1, wherein the astaxanthin has a chemical structural diagram of

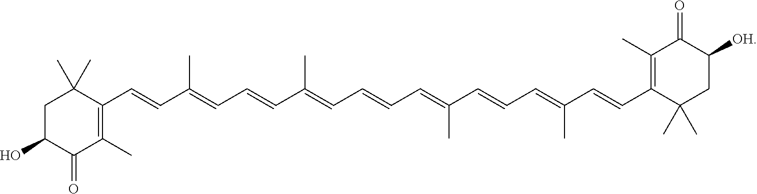 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

3. The hydrogel composition of claim 1, further comprising hydrophilic monomer, cross-linking agent, and initiator; wherein the astaxanthin is combined and dispersed in the hydrophilic monomer, the cross-linking agent, and the initiator.

4. The hydrogel composition of claim 3, wherein the hydrophilic monomer has a mass percentage of 56% to 99.82%, the cross-linking agent has a mass percentage of about 0.03% to about 21.82%, and the initiator has a mass percentage of about 0.042% to about 18.62%.

5. A method for manufacturing a contact lens, comprising:
preparing a hydrogel composition comprising astaxanthin, wherein the astaxanthin has a mass percentage of 0.004% to 5%;
putting the hydrogel composition into a mold; and
heating the hydrogel composition or irradiating the hydrogel composition under ultraviolet light to form the contact lens.

6. The method of claim 5, wherein the astaxanthin has a chemical structural diagram of

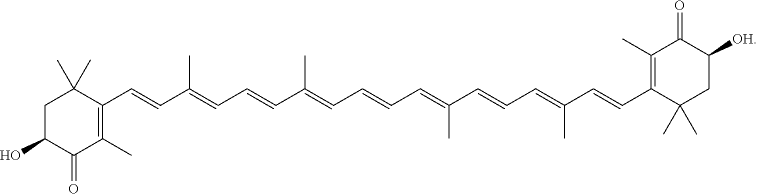 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

7. The method of claim 5, wherein the hydrogel composition further comprises:
hydrophilic monomer, cross-linking agent, and initiator wherein the hydrophilic monomer, the cross-linking agent, and the initiator undergo a polymerization reaction to form a cross-linking network, and the astaxanthin is combined and dispersed in the cross-linking network.

8. The method of claim 7, wherein the hydrophilic monomer has a mass percentage of 56% to 99.82%, the cross-linking agent has a mass percentage of 0.03% to 21.82%, the initiator has a mass percentage of 0.042% to 18.62%.

9. The method of claim 5, wherein the hydrogel composition is heated between 0.5 hours to 8 hours at a temperature between 60 degrees Celsius to 90 degrees Celsius.

10. The method of claim 5, wherein the hydrogel composition is irradiated under ultraviolet light between 5 minutes to about 30 minutes.

11. A contact lens, comprising a gel substrate having astaxanthin, wherein the astaxanthin has a mass percentage of 0.004% to 5%.

12. The contact lens of claim 11, wherein the astaxanthin has a chemical structural diagram of

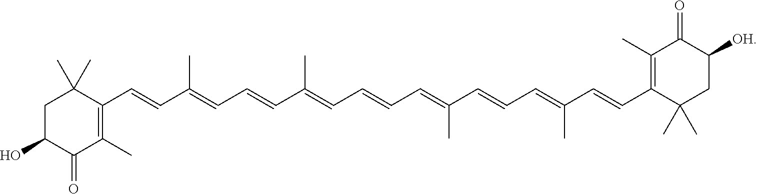 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

13. The contact lens of claim 11, wherein the gel substrate further comprises hydrophilic monomer, cross-linking agent, and initiator; wherein the astaxanthin is combined and dispersed in a cross-linking network formed from the hydrophilic monomer, the cross-linking agent, and the initiator.

14. The contact lens of claim 11, wherein the hydrophilic monomer has a mass percentage of 56% to 99.82%, the cross-linking agent has a mass percentage of 0.03% to 21.82%, and the initiator has a mass percentage of 0.042% to 18.62%.
